(19) United States
(12) Patent Application Publication
(10) Pub. No.: US 2008/0222685 A1
(43) Pub. Date: Sep. 11, 2008

(54) Karaoke system provided through an internet protocol television system

(75) Inventors: Mary McCarthy, San Antonio, TX (US); Roland Noll, San Antonio, TX (US); Scott Pettit, San Antonio, TX (US); Bryan Cardenas, Helotes, TX (US); Anthony J. Truppa, Palantine, IL (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/716,369

(22) Filed: Mar. 9, 2007

(51) Int. Cl. H04N 7/173

(52) U.S. Cl. 725/100

(57) ABSTRACT

Particular embodiments of the disclosed subject matter provide methods and systems to support a karaoke system provided via a set-top box and internet protocol television system. An example embodiment includes an apparatus and system to receive a karaoke content user selection through a user interface of a set-top box, send the karaoke content user selection to a VOD server via a network, enable access to selected karaoke content corresponding to the karaoke content user selection from the VOD server, and to enable viewing of the selected karaoke content on a display device via the set-top box. The set-top box further includes a karaoke input interface and a storage device operable to store karaoke input received via the karaoke input interface.

### TECHNICAL FIELD

The disclosed subject matter relates to the field of karaoke systems and television, and more particularly to systems and methods supporting karaoke systems provided through an internet protocol television system.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006-2007, SBC Knowledge Ventures L.P. and/or AT&T Knowledge Ventures, All Rights Reserved.

### BACKGROUND

Conventional systems provide the capability for interactive karaoke entertainment. Conventional karaoke systems include a microphone developing an audio input from at least one karaoke performer; a camera producing a series of video frames including the karaoke performer; and a karaoke processor system including a video environment and a related audio environment for the karaoke performer. The karaoke processor system is coupled to the camera to create extracted images of the karaoke performer from the series of video frames and to composite the extracted images with a background derived from the video environment. The video environment is affected by the position and movement of the karaoke performer. A conventional karaoke network includes a local area network, a local karaoke server coupled to the local area network and storing local karaoke content; and a number of karaoke systems coupled to the local area network, each of which can request karaoke content from the local karaoke server.

However, conventional karaoke systems cannot integrate with an internet protocol television (IPTV) system. Karaoke input, including real-time generated audio and video content, cannot be received and processed by conventional set-top boxes (STB's). Further, conventional set-top boxes cannot store karaoke content locally on the set-top box. As such, special karaoke equipment and software is needed to support a conventional karaoke system.

Thus, systems and methods supporting karaoke systems provided through an internet protocol television system are needed.

### BRIEF DESCRIPTION OF THE DRAWINGS

FIG. 1 is a block diagram illustrating an example embodiment of an Internet Protocol Television (IPTV) system with a karaoke capability;

FIG. 2 illustrates various example embodiments of a karaoke system in accordance with the disclosed subject matter.

FIG. 3 illustrates an example embodiment of a computing system in accordance with the disclosed subject matter.

FIG. 4 is a processing flow diagram illustrating various methods related to example embodiments of a karaoke system in accordance with the disclosed subject matter.

FIG. 5 illustrates one example embodiment of a set-top box in which a karaoke input interface is provided.

FIG. 6 illustrates the VOD backend system of an example embodiment.

FIG. 7 illustrates the VOD acquisition and delivery subsystems of an example embodiment.

### DETAILED DESCRIPTION

In the following detailed description, reference is made to the accompanying drawings that form a part hereof, and in which are shown by way of illustration, specific embodiments in which the disclosed subject matter can be practiced. It is understood that other embodiments may be utilized and structural changes may be made without departing from the scope of the disclosed subject matter.

As described further below, according to various example embodiments of the disclosed subject matter described herein, there is provided systems and methods supporting karaoke systems provided through an internet protocol television system. The system can include a set-top box device comprising a processor and a memory accessible to the processor. The system can also include a computer program embedded within the memory and executable by the processor, the computer program comprising instructions to receive a user interface at the set-top box device via a private network within an Internet Protocol Television (IPTV) system, where the user interface includes a capability to select, capture, and play karaoke content via a public network. The set-top box device can be associated with a public network user account at a server within the IPTV system, and at least one type of karaoke content can be associated with a user preference received at the public network user account.

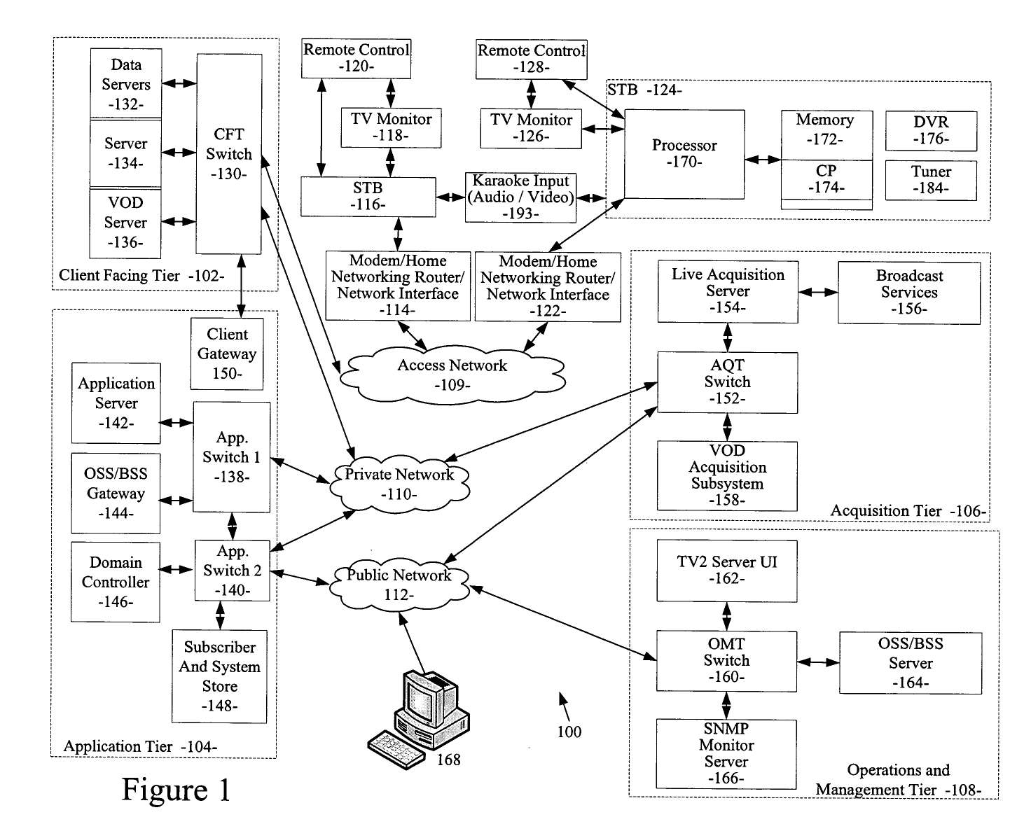

Referring to FIG. 1, an example embodiment of an IPTV system is shown and is generally designated 100. As shown, the system 100 can include a client facing tier 102, an application tier 104, an acquisition tier 106, and an operations and management tier 108. Each tier 102, 104, 106, 108 is coupled to a private network 110, a public network 112, or both the private network 110 and the public network 112. For example, the client-facing tier 102 can be coupled to the private network 110. Further, the application tier 104 can be coupled to the private network 110 and to the public network 112, such as the Internet. The acquisition tier 106 can also be coupled to the private network 110 and to the public network 112. Moreover, the operations and management tier 108 can be coupled to the public network 112.

As shown in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

As illustrated in FIG. 1, the client-facing tier 102 can communicate with user equipment via a private access network 109, such as an Internet Protocol Television (IPTV) network. In an illustrative embodiment, conventional network interface devices including modems, home networking routers, and network interface hardware can be used to connect a user to the private access network 109. As shown in FIG. 1, modem/home networking router/network interface devices (denoted herein as network interfaces) 114 and 122 can be coupled to the private access network 109. The client-facing tier 102 can communicate with a first representative set-top box device 116 via the first network interface 114 and with a second representative set-top box device 124 via the second network interface 122. The client-facing tier 102 can similarly communicate with a large number of set-top boxes, such as the representative set-top boxes 116, 124, over a wide geographic area, such as a regional area, a metropolitan area, a viewing area, or any other suitable geographic area that can be supported by networking the client-facing tier 102 to numerous set-top box devices.

In one embodiment, the client-facing tier 102 can be coupled to the network interfaces 114, 122 via fiber optic cables. Alternatively, the network interfaces 114 and 122 can include digital subscriber line (DSL) modems that are coupled to one or more network nodes via twisted pairs, and the client-facing tier 102 can be coupled to the network nodes via fiber-optic cables. Each set-top box device 116, 124 can process data received via the private access network 109, via an IPTV software platform, such as Microsoft® TV IPTV Edition.

Additionally, the first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device 124 can communicate with a second remote control 128.

In an exemplary, non-limiting embodiment, each set-top box device 116, 124 can receive data or video from the client-facing tier 102 via the private access network 109 and render or display the data or video at the display device 118, 126 to which it is coupled. In an illustrative embodiment, the set-top box devices 116, 124 can include tuners, such as the tuner 184 shown in FIG. 1, that receive and decode television programming information for transmission to the display devices 118, 126. Further, the set-top box devices 116, 124 can include a STB processor 170 and a STB memory device 172 that is accessible to the STB processor 170. In a particular embodiment, the set-top box devices 116, 124 can also communicate commands received from the remote control devices 120, 128 back to the client-facing tier 102 via the private access network 109.

In an illustrative embodiment, the client-facing tier 102 can include a client-facing tier (CFT) switch 130 that manages communication between the client-facing tier 102 and the private access network 109 and between the client-facing tier 102 and the private network 110. As shown, the CFT switch 130 is coupled to one or more data servers 132 that store data transmitted in response to user requests, such as video-on-demand content. The CFT switch 130 can also be coupled to a server 134 that provides support for terminal devices and other devices with a common connection point to the private network 110. In a particular embodiment, the CFT switch 130 can also be coupled to a video-on-demand (VOD) server 136.

As shown in FIG. 1, the application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116, 124 via the private access network 109, so the set-top box devices 116, 124 can provide functions, such as display, messaging, processing of IPTV data and VOD material, etc. In a particular embodiment, the OSS/BSS gateway 144 includes operation systems and support (OSS) data, as well as billing systems and support (BSS) data.

Further, the second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116, 124 can access the system 100 via the private access network 109, using information received from the client gateway 150. The private access network 109 provides security for the private network 110. User devices can access the client gateway 150 via the private access network 109, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 109.

For example, when a set-top box device 116 accesses the system 100 via the private access network 109, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and/or VOD content delivered via VOD server 136. If the client gateway 150 cannot verify subscriber information for the set-top box device 116, e.g., because it is connected to a different twisted pair, the client gateway 150 can deny transmissions to and from the set-top box device 116 beyond the private access network 109.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch 152 can be coupled to a video-on-demand acquisition subsystem 158 that stores television content received at the acquisition tier 106 and communicates the stored content to the client-facing tier 102 via the private network 110.

FIG. 1 further illustrates that the operations and management tier 108 can include an operations and management tier (OMT) switch 160 that manages communication between the operations and management tier 108 and the public network 112. In the embodiment illustrated in FIG. 1, the OMT switch 160 is coupled to a TV2 server 162. Additionally, the OMT switch 160 can be coupled to an OSS/BSS server 164 and to a simple network management protocol (SNMP) monitor 166 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 can transmit the television content to the AQT switch 152, in turn, and the AQT switch 152 can transmit the television content to the CFT switch 130 via the private network 110. Further, the CFT switch 130 can communicate the television content to the network interfaces 114, 122 via the private access network 109. The set-top box devices 116, 124 can receive the television content from the network interfaces 114, 122, decode the television content, and transmit the content to the display devices 118, 126 according to commands from the remote control devices 120, 128.

Additionally, at the acquisition tier 106, the video-on-demand (VoD) acquisition subsystem 158 can receive video-on-demand content from one or more VoD sources outside the IPTV system 100. Additionally, in the various embodiments described herein, the video-on-demand (VoD) acquisition subsystem 158 can also receive karaoke content comprising audio (e.g. music) and/or video (e.g. backgrounds). This karaoke content can be maintained in a karaoke content library in a fashion similar to the video-on-demand content library maintained by the VOD Server 136. The audio and/or video content associated with a particular karaoke selection is generally denoted herein as the karaoke content. The VoD acquisition subsystem 158 can transmit the karaoke content to the AQT switch 152, and the AQT switch 152, in turn, can communicate the karaoke content to the CFT switch 130 via the private network 110. The karaoke content can be stored within the plurality of data servers 132.

When a user issues a request for the usage of a particular selection of karaoke content through a set-top box device 116, 124, the request can be transmitted over the private access network 109 to the VOD server 136, via the CFT switch 130. Upon receiving such a request, the VOD server 136 can retrieve the requested karaoke content from the plurality of data servers 132 and transmit the requested karaoke content to the requesting set-top box device 116,124 across the private access network 109, via the CFT switch 130. The karaoke content may be subsequently processed by and/or stored in the requesting set-top box device 116,124 as described in more detail below.

These embodiments enable a user to request a particular selection of karaoke content in a similar manner that a user can presently order and purchase a video-on-demand movie using a conventional set-top box. That is, a user can be presented with a catalog of karaoke content selections (e.g. songs with associated lyrics, animations, and/or video) available in the karaoke content library maintained by the VOD Server 136. The user can use the remote control device 120,128 to make a karaoke content selection and initiate the process described above. Because the embodiments described herein enable a user to request a particular selection of karaoke content in a similar manner that a user can presently order and purchase a video-on-demand movie, the billing and payment infrastructures already existing for video-on-demand movie order/purchase can also be used for karaoke content order/purchase. That is, karaoke content purchases can be debited to a user account previously established for a user subscription to a cable, satellite, telephone, or other conventional service. In this way, the various embodiments are advantageous over existing systems that require a separate user interface for ordering and credit card billing. The various embodiments as described below enable a user to manage his/her account using a web portal.

In an illustrative embodiment, the live acquisition server 154 can transmit the television content to the AQT switch 152, and the AQT switch 152, in turn, can transmit the television content to the OMT switch 160 via the public network 112. In this embodiment, the OMT switch 160 can transmit the television content to the TV2 server 162 for display to users accessing the user interface at the TV2 server 162. For example, a user can access the TV2 server 162 using the computer 168 coupled to the public network 112.

As shown in FIG. 1, the domain controller 146 communicates with the public network 112 via the second APP switch 140. Additionally, the domain controller 146 can communicate via the public network 112 with one or more user computers 168 (e.g. a personal computer or PC). For example, the domain controller 146 can display a web portal via the public network 112 and allow users to access the web portal using a PC 168. In this manner, the user can use the PC 168 to access a web portal maintained by the domain controller 146, via the public network 112. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124, by associating the user account with an IP address of the second set-top box device 124, with data relating to one or more twisted pairs connected with the second set-top box device 124, with data relating to one or more fiber optic cables connected with the second set-top box device 124, with an alphanumeric identifier of the second set-top box device 124, with any other data that is suitable for associating second set-top box device 124 with a user account, or with any combination of these.

In a particular embodiment, after the domain controller 146 has authenticated and verified the user, the domain controller 146 can allow the user to access his or her public data network user account, such as an Internet account, via the PC 168. The user can enter preferences to the user account via the PC 168. Each preference can indicate a type of content that the user prefers to play in conjunction with a web browser at the PC 168 and/or with a television display transmitted to a display device 118, 126 by a set-top box device 116, 124. Further, the user can enter karaoke content preferences to the user account via the PC 168.

Upon receiving one or more user preferences from the user via the PC 168, the domain controller 146 can generate a user interface, or data associated with rendering a user interface, that incorporates the preferences received from the user. The user interface or related data can be associated with the user's set-top box device 116, 124 and stored in conjunction with the user's Internet account. This information may be stored at the domain controller 146, at the subscriber and system store 148, or at any one or more components of the IPTV system 100 that are suitable for storing a user interface in conjunction with a set-top box identification and for communicating the user interface or related data to a web browser via the PC 168 and to a set-top box 116, 124 via the private access network 109.

In an exemplary, non-limiting embodiment, a user can request that the user interface associated with the user's set-top box device be displayed in conjunction with a web browser at the PC 168. The user interface, or data associated with the user interface, can be transmitted by the domain server 146 to the PC 168 via the public network 112. The PC 168 can display the user interface via its screen or monitor, or the PC 168 can generate and render the user interface from related data that it has received via its display. The user interface can overlay a portion of the web browser, or at least partially frame the web browser.

In another example embodiment, the user can request that the user interface be displayed in conjunction with television content at a display device 118, 126. The request can be received from the user's set-top box 116, 124 at the CFT switch 130 via the private access network 109. The request can be transmitted by the CFT switch 130 via the private network 112 to the device that stores the user interface, or data associated with the user interface, in conjunction with the user's account, such as the domain controller 146 or the subscriber and system store 148. The user interface or related data can be received at the CFT switch 130 and transmitted to the requesting set-top box device 116, 124 via the private access network 109. In a particular embodiment, the CFT switch 130 can also transmit television programming that it receives from the acquisition tier 106 along with the user interface.

As shown in FIG. 1, a set-top box device, such as the second set-top box device 124, can include a processor 170 and a memory device 172 that is accessible to the processor 170. The set-top box device 124 can also include a computer program 174 that is embedded within the memory device 172. In a particular embodiment, the computer program 174 can include instructions to receive a user interface and/or karaoke content that incorporate at least one content preference that a user has entered at a user account on a public network via the domain controller 146. In another embodiment, the computer program 174 can include instructions to receive data associated with the user interface and/or karaoke content and instructions to generate and render the user interface and/or karaoke content at the display device 118, 126. The user interface and/or karaoke content can overlay a portion of the television programming, or at least partially frame the television programming, when the user interface and/or karaoke content is displayed at the display device 118, 126.

In an illustrative embodiment, the computer program 174 can include instructions to receive selections of web content at the set-top box device 124 via the user interface and to transmit web content to the display device 126. For instance, a user can make selections on the user interface or control movements using a remote control 128 to communicate with the set-top box device 124. After the set-top box device 124 receives the user's selection/control movement data, the set-top box device 124 can transmit the selection/control movement data to the CFT switch 130 via the private access network 109. The CFT switch 130 can transmit the selection/control movement data to the domain controller 146 via the private network 110, for example, and the domain controller 146 can retrieve the requested web content from the public network 112. The selected web content can be communicated back to the CFT switch 130 and to the set-top box device 124 via the private access network 109. The set-top box device 124 can receive the selected content and transmit it to the display device 126 for display to the user.

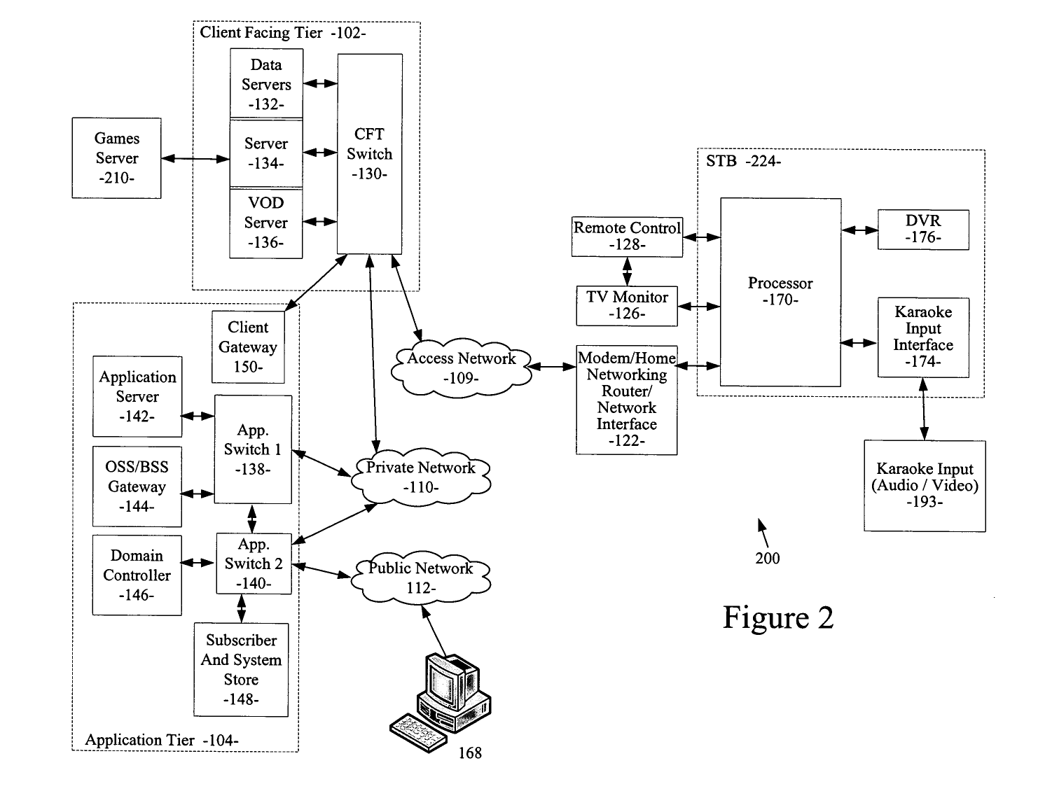

Referring to FIG. 2, an example embodiment is shown and is generally designated as system 200. In system 200, a VOD Server 136 is shown as included in client facing tier 102. As described above, various types of karaoke content can be maintained in the karaoke content library maintained by the VOD Server 136. In this configuration, karaoke content selections can be viewed and made accessible to a user via set-top box 224. The VOD Server 136 can communicate with set-top box 224 via Internet Protocol. The karaoke content selections viewable to the end user at TV monitor 126 can be accessed and purchased via several entry points on the television monitor 126 and controlled via a user interface with the remote control device 128. Each entry point in the user interface can enable the user to switch from a live video stream on an acquisition server 154 in the network to view the karaoke content library maintained by VOD Server 136. The user interface can further enable the user to purchase and initiate transfer or streaming of a selected karaoke content selection from the VOD server 136, through set-top box 224. Karaoke input interface 174 can be implemented as a conventional USB interface; but, those of ordinary skill in the art will recognize that other types of karaoke input interfaces may equivalently be used. In general, karaoke input interface 174 receives audio and/or video input from a karaoke input source 193. Karaoke input source 193 includes a standard microphone or other audio source and a video camera or other video source.

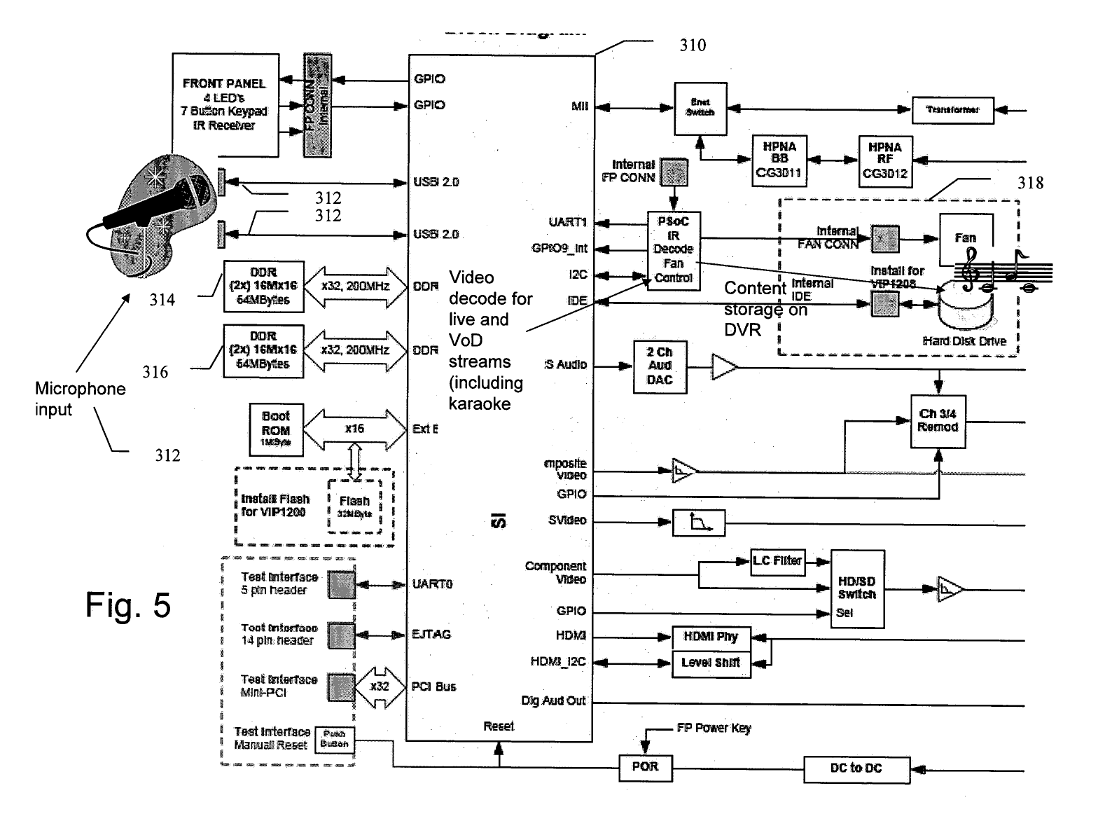

FIG. 5 illustrates one example embodiment of a set-top box 310 in which a karaoke input interface 312 is provided. In this example, a microphone is coupled to the set-top box 310 via a conventional USB interface. It will be apparent to those of ordinary skill in the art that other equivalent karaoke input devices may similarly be connected to set-top box 310. As shown in FIG. 5, set-top box 310 can also be configured to receive video inputs from live and/or VOD sources via inputs 314 and 316. As also shown in FIG. 5, the video content received via inputs 314 and 316 and the karaoke input from karaoke input interface 312 can be stored on a storage device 318 (e.g. a digital video recorder or DVR) on the set-top box 310 or coupled to the set-top box 310.

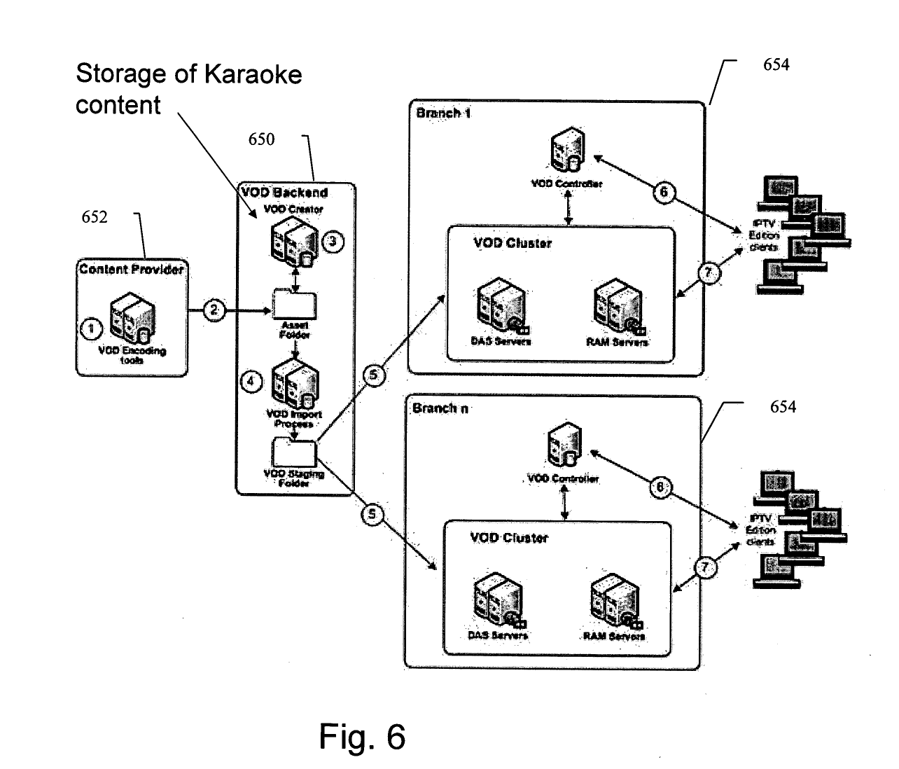

FIG. 6 illustrates the VOD backend system of an example embodiment. As shown in FIG. 6, a content provider 652 can provide tools for encoding video content, including karaoke content, into a form supported by a VOD backend subsystem 650. VOD backend subsystem 650 can be used to create karaoke content that can be stored in a VOD karaoke content library and accessed by users via a set-top box and the network. A plurality of branches 654 comprising VOD clusters can be used to service a plurality of IPTV clients, such service including providing a means for accessing selected karaoke content from a karaoke content library created and maintained by the VOD backend subsystem 650.

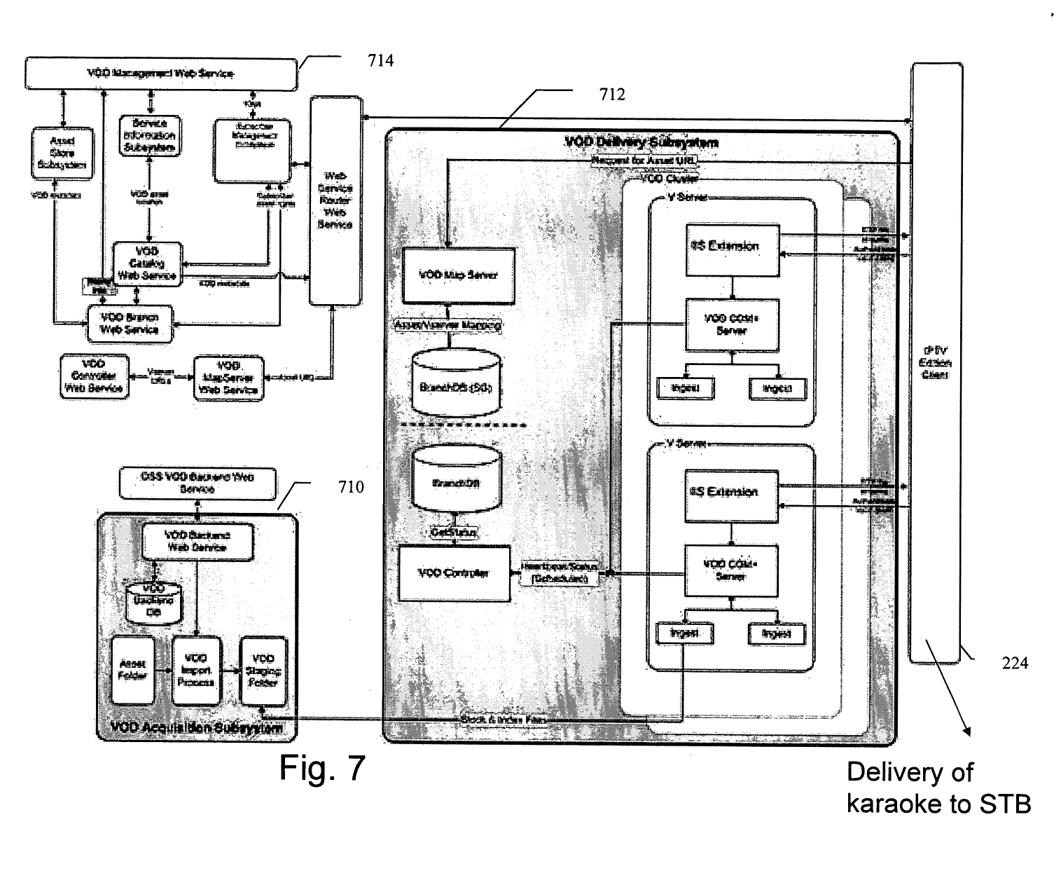

FIG. 7 illustrates the VOD acquisition and delivery subsystems of an example embodiment. As shown in FIG. 7, a VOD acquisition subsystem 710 can be used to acquire audio and/or video content, including karaoke content, and encode the content into a form supported by a VOD backend web service subsystem 710. VOD backend web service subsystem 710 can be used to create karaoke content that can be stored in a VOD karaoke content library and accessed by users via a VOD delivery subsystem 712 and set-top box 224 via the network. The VOD delivery subsystem 712, of an example embodiment as shown in FIG. 7, provides plurality of branches comprising VOD clusters that can be used to service a plurality of IPTV clients via a set-top box 224. The VOD delivery service includes providing a means for accessing selected karaoke content from a karaoke content library created and maintained by the VOD backend web service subsystem 710.

In general, the system of an example embodiment comprises a television monitor including a remote control device, a set-top box connectable with the television monitor and with a network, and a VOD Server connectable with the set-top box via the network, the VOD Server to receive a karaoke content user selection via the set-top box, to enable viewing and/or local storage of the karaoke content selection from the VOD Server via the set-top box and the network, and to enable viewing and/or storage of karaoke content received via a karaoke input interface in the set-top box.

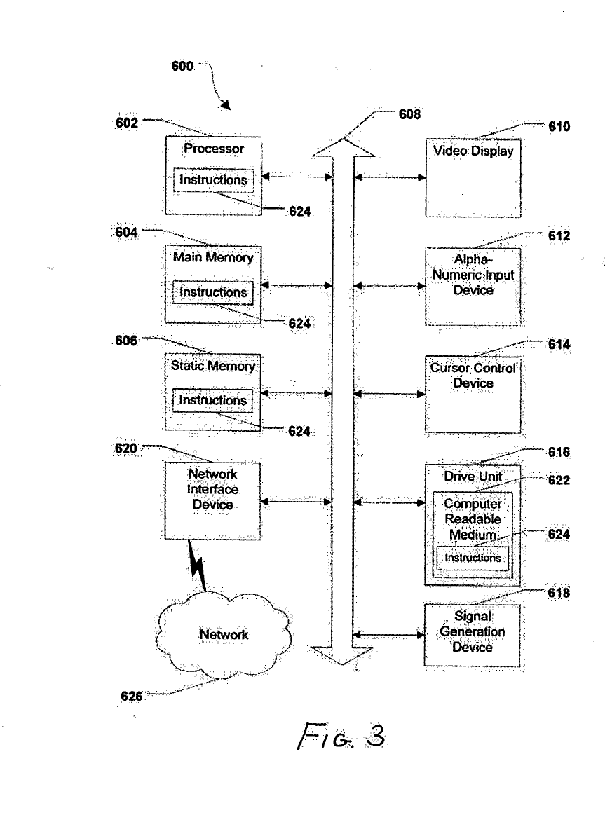

Referring to FIG. 3, an illustrative embodiment of a general computer system is shown and is designated 600. The computer system 600 can include a set of instructions that can be executed to cause the computer system 600 to perform any one or more of the methods or computer based functions disclosed herein. The computer system 600, or any portion thereof, may operate as a standalone device, such as the set-top box devices and servers shown in FIGS. 1-2, or may be connected, e.g., using a public network or a private network within an IPTV system, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 3, the computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. When the computer system 600, or any portion thereof, is embodied in a set-top box device, the cursor control device 614 can be a remote control device. The computer system 600 can also include a disk drive unit 616, a signal generation device 618, such as a speaker or remote control, and a network interface device 620.

In a particular embodiment, as depicted in FIG. 3, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In conjunction with the configuration of structure and methods described herein, systems and methods for a karaoke system provided through an internet protocol television system are described. The karaoke content is selectable and can be transferred or streamed via an interactive user interface that may be linked to a user's preferences. By associating user accounts with set-top box devices at the server level, preferences will be retrieved and recognized without the need for a user to log in to his or her television. Moreover, by attaching set-top box devices to Internet accounts, users can access and download personalized karaoke content.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

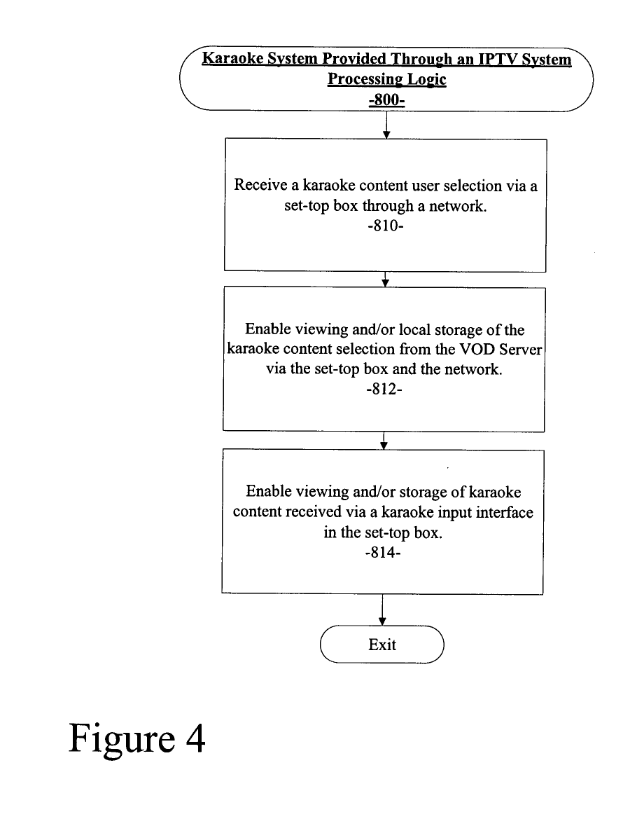

FIG. 4 is processing flow diagram illustrating various methods related to example embodiments of a karaoke system in accordance with the disclosed subject matter. As shown in FIG. 4, an example method includes receiving a karaoke content user selection via a set-top box through a network (processing block 810), enabling viewing and/or local storage of the karaoke content selection from the VOD Server via the set-top box and the network (processing block 812); and enabling viewing and/or storage of karaoke content received via a karaoke input interface in the set-top box (processing block 814).

In support of a consumer billing infrastructure as part of the karaoke system of the various embodiments as described above, the karaoke system platform is integrated with IPTV ordering and billing systems in an example embodiment to ensure the customer is billed in a similar fashion to linear subscriptions or Video-on-Demand (VoD) purchases. IPTV ordering and billing systems can include paid subscription-based content (MRC and ARC) and usage-based content (pay-per-play) that can be accessed as follows in an example embodiment:
Provisioned as a Channel in the television guide
Provided from the Main Menu
Remote Control keypress (e.g., Go Interactive button).
Provided through a “karaoke storefront”
Provided with Multi-Platform karaoke functionality—IPTV, Broadband, Wireless

In various embodiments, the provisioning of the payment options and the promotion of karaoke content can be implemented in various ways. In one embodiment, both free and purchasable content (subscription-based and usage-based) can be provisioned as a Main Menu selection (either interactive sub-menu or through a “karaoke storefront”), and via the Remote Control (e.g., Karaoke Content Purchase button). The IPTV system presents viewers who are not subscribed to the content with a purchase sequence for purchasable content (e.g. subscription-based and pay-per-play), whether accessed from a linear content channel, Main Menu, or Remote Control key press (e.g., Karaoke Content button). The purchase sequence top screen includes an offer panel and displays either a static full screen promotion (e.g. poster art) or karaoke content promotion when the channel is selected by the customer. In an example embodiment, the purchase sequence will maintain the “look and feel” of a VoD or pay-per-view (PPV) purchase so as not to confuse the customer. Customers are provided with the ability to “trial” subscription packages and pay-per-play content. This can be handled similarly to the preview before a VoD purchase. In one embodiment, the meta-data surrounding the karaoke content will include some functionality that is rated at a $0 price point (i.e. free trial functionality). The core of the karaoke content (i.e. full functionality) will have a real price point (i.e. a price greater than $0) attached to the full functionality. Customers selecting the free trial option will be presented with screen that includes karaoke content poster art, package description, duration of trial period and a “Try It Free” button. When the “Try it Free” button is selected, customers can receive a viewing and/or storage grant and can get redirected to the Karaoke Content Top Page for the selected package or pay-per-play content. In an example embodiment, flexible trial period parameters, e.g., 1-hour, 24-hours, 3-day pass, 30-day trial can be configured. These settings can be configurable within IPTV. In an example embodiment, these settings will be included in the karaoke content meta-data similarly to the “tar-ball” associated with VoD licensing. For subscription content, trial periods can be restricted.

Subscription and usage-based content can be billed separately, or may also be bundled with other video assets to up-sell bolt-on packages (VoD, SVoD and PPV). Below are some price packaging examples to illustrate the desired functionality.

Content Subscription Package-Only
Customer orders a Content Subscription Package for $x.xx/month. This is a monthly recurring charge (MRC).

On Demand (SVoD)+Content Subscription Package
Customer orders an On Demand content service for $x.xx and gets a Content subscription package free for the first month and $x.xx thereafter at a bundled pricing discount.

Kids+Content Subscription Package
Customer orders a Kids content service for $x.xx/month and gets a Karaoke content subscription package free for the first month and $x.xx thereafter at a bundled pricing discount.

All in One Package
Customer orders a Classics content service+Kids content service+On Demand content service+Karaoke content at bundled price of $xx.xx/month

VoD Purchase+Content Pass (Trial)
Customer orders a VoD movie and gets a free 3-day Karaoke content Pass. After 72-hours, the consumer would be notified and prompted to purchase a Karaoke content Subscription.

Various embodiments include the ability for customers to purchase a bundle of units for a one-time charge, e.g., “5 Plays for $5”, and receive a purchase display when each unit is consumed. That is, for example, if the customer is using the third consumption of the “5 Plays for $5”, the customer can be advised that they have two more units available as part of the original purchase. Various embodiments include usage based promotions for karaoke such that a buy x units within y period can be supported. Various embodiments also support loyalty-based programs for karaoke. For example, a loyalty program can accumulate “karaoke” points based on time/spend/performance by a user. A loyalty program can enable a user to redeem points for cash/prize/IPTV discounts. This can be expanded across IPTV to drive revenue and user interaction, and reduce chum.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of ordinary skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus comprising:
a video-on-demand (VOD) server connectable with a set-top box via a network, the VOD server to receive a karaoke content user selection via a set-top box through the network, to enable access to the selected karaoke content from the VOD server, and to enable viewing of the selected karaoke content on a display device via the set-top box.

2. The apparatus as claimed in claim 1 wherein the VOD server being further operable to enable local storage of the selected karaoke content on the set-top box.

3. The apparatus as claimed in claim 1 wherein the karaoke content includes one from the group of: audio content and video content.

4. A system comprising:
a set-top box including a karaoke input interface; and
a video-on-demand (VOD) server connectable with the set-top box via a network, the VOD server to receive a karaoke content user selection via the set-top box through the network, to enable access to the selected karaoke content from the VOD server, and to enable viewing of the selected karaoke content on a display device via the set-top box.

5. The system as claimed in claim 4 wherein the set-top box further includes a storage device operable to store the selected karaoke content on the set-top box.

6. The system as claimed in claim 4 wherein the set-top box further includes a storage device operable to store karaoke input received via the karaoke input interface.

7. The system as claimed in claim 4 wherein the karaoke content includes one from the group of: audio content and video content.

8. An apparatus comprising:
a set-top box connectable with a video-on-demand (VOD) server via a network, the set-top box to receive a karaoke content user selection provided by a user of the set-top box, to communicate the karaoke content selection to the VOD server, to receive the selected karaoke content from the VOD server, and to enable viewing of the selected karaoke content on a display device.

9. The apparatus as claimed in claim 8 wherein the set-top box further includes a storage device operable to store the selected karaoke content on the set-top box.

10. The apparatus as claimed in claim 8 wherein the set-top box further includes a karaoke input interface and a storage device operable to store karaoke input received via the karaoke input interface.

11. The apparatus as claimed in claim 8 wherein the karaoke content includes one from the group of: audio content and video content.

12. A method comprising:
receiving a karaoke content user selection through a user interface of a set-top box;
sending the karaoke content user selection to a VOD server via a network;
enabling access to selected karaoke content corresponding to the karaoke content user selection from the VOD server; and
enabling viewing of the selected karaoke content on a display device via the set-top box.

13. The method as claimed in claim 12 including enabling local storage of the selected karaoke content on the set-top box.

14. The method as claimed in claim 12 wherein the karaoke content includes one from the group of: audio content and video content.

15. An article of manufacture comprising at least one machine readable storage medium having one or more computer programs stored thereon and operable on one or more computing systems to: receive a karaoke content user selection through a user interface of a set-top box, send the karaoke content user selection to a VOD server via a network, enable access to selected karaoke content corresponding to the karaoke content user selection from the VOD server, and to enable viewing of the selected karaoke content on a display device via the set-top box.

16. The article of manufacture as claimed in claim 15 wherein the VOD server being further operable to enable local storage of the selected karaoke content on the set-top box.

17. The article of manufacture as claimed in claim 15 wherein the karaoke content includes one from the group of: audio content and video content.
